(19) United States
(12) Patent Application Publication
(10) Pub. No.: US 2007/0029408 A1
(43) Pub. Date: Feb. 8, 2007

(54) Throttleable swirling injector for combustion chambers

(75) Inventor: Ross A. Hewitt, Sacramento, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aerojet-General Corporation, Sacramento, CA (US)

(21) Appl. No.: 11/196,546

(22) Filed: Aug. 2, 2005

(51) Int. Cl. B05B 1/34

(52) U.S. Cl. 239/463; 239/488

(57) ABSTRACT

A throttling injector is constructed with a swirl chamber, a plurality of tangentially directed liquid fuel inlets and an outlet orifice, the inlets arranged to create a swirling flow in the swirl chamber to leave through the outlet in a stream that is in the shape of a hollow tube or cone. Variations in the number of inlets that are actuated results in variations in the thickness of the wall of liquid in the tube or cone and hence variations in the volumetric flow rate of fuel ejected from the outlet orifice without changing the linear velocity of the fuel in the axial direction through the orifice or the pressure drop across the orifice. The injector thus permits throttling to occur from a high to a low volumetric fuel flow rate without the chugging instability that plagues liquid-fuel-fed combustion chambers of the prior art.

### BACKGROUND OF THE INVENTION

1. Field of the Invention

This invention resides in the field of liquid-fuel combustion engines, and particularly the fuel injectors for such engines.

2. Description of the Prior Art

Combustion engines powered by liquid fuel are used in a variety of applications. Examples are gas turbines, pre-burners, liquid-propellant rocket motors, and descent engines of space shuttles. In many of these applications, a controlled shutdown, typically involving throttling the engine in a gradual or stepwise manner, is critical to the successful operation of the engine. In thrust-producing engines, a thrust ratio of 30:1 or greater is needed upon shutdown. When throttling is performed at very high ratios or at very rapid rates, the rapid changes of pressure and the transmission of these changes throughout the system produce a combustion instability in the form of a series of low-pressure fluctuations known as “chugging.”

Attempts in the prior art to control chugging have included the foaming of the propellant by the injection of an inert gas into the propellant feed lines, as disclosed by Morrell, G., U.S. Pat. No. 3,045,424 (Jul. 24, 1962), Biehl, R. E., et al., U.S. Pat. No. 3,266,236 (Aug. 16, 1966), Jennings, J. J., U.S. Pat. No. 3,266,241 (Aug. 16, 1966), and Braue, J. W., U.S. Pat. No. 3,302,406 (Feb. 7, 1967). The purpose of the addition of the inert gas is to reduce the amount of fuel being fed without reducing the velocity. In an alternative method, the injection head contains a mechanical device that varies the injection orifice areas for the fuel and oxidizer. An injection head of this type was reported by Elverum, G., Jr., et al., “The Descent Engine for the Lunar Module,” Paper No. 67-521, AIAA 3rd Propulsion Joint Specialist Conference, Washington D.C., Jul. 17-21, 1967. The injection head in this paper supplies both fuel and oxidizer and extends into the combustion chamber. The head contains a multitude of openings for each of the two liquids plus a movable control sleeve that closes the openings, the number closed depending on the position of the sleeve. Since the injection head extends into the combustion chamber, the sleeve is exposed to the hot combustion gas.

Of further possible relevance to this invention is published literature relating to swirl-type pressure nozzles used for spray drying, and swirl-type coaxial injectors used for rocket launch engines. Swirl-type pressure nozzles are described by Marshall, W. R., Jr., in Atomization and Spray Drying, “Chapter II. Performance Characteristics of Centrifugal- or Swirl-Type Pressure Nozzles,” Chemical Engineering Progress Monograph Series, No. 2, Vol. 50, pp. 12-30, American Institute of Chemical Engineers (1954). A swirl-type coaxial injector is described by Hulka, J., et al., in “Performance and Stability of a Booster Class LOX/H₂ Swirl Coaxial Element Injector,” AIAA Paper No. 91-1877, AIAA/SAE/ASME 27th Joint Propulsion Conference, Sacramento, Calif., Jun. 24-26, 1991.

The contents of all references in this section are incorporated herein in their entirety.

### SUMMARY OF THE INVENTION

The present invention resides in a throttling injector that achieves thrust variation by spinning the liquid fuel around the internal wall of a swirl chamber, causing the liquid to be ejected from the chamber around the rim of an orifice in the chamber wall, with thrust variation being achieved by varying the volume of liquid entering the swirl chamber and thereby varying the depth of the layer of the peripheral liquid stream at the outlet orifice rim. The liquid stream that is ejected from the swirl chamber through the outlet orifice will thus occupy only a small fraction of the outlet orifice area at low volumetric flow rates or a majority of, and possibly the entire, outlet orifice area at higher flow rates, and various levels in between. The volumetric flow of liquid fuel that is fed through inlet orifices to the swirl chamber can be varied by continuous changes in the flow rate through an inlet line or through a series of inlet lines that feed the liquid to the chamber, or by stepwise changes produced by opening and closing different numbers of liquid fuel inlets to the swirl chamber. Variation can also be achieved by using inlets of different sizes, or by changes in the manner in which the liquid fuel is directed to individual inlets. All of these variations can be made without any substantial change in the linear velocity of liquid through the outlet orifice, and without any substantial change in the pressure drop, if any, across the orifice. Throttling of the combustion engine by decreasing the volumetric flow of fuel from the injector can thus be achieved without exposing any moving parts to hot combustion gases, and without any need for injecting gas or additives to the fuel or for maintaining a foam or dispersion of any kind in the fuel. A wide throttling range can be achieved by constructing the swirl chamber with a large number of inlets, and further flexibility can be achieved by using inlets of different sizes. Chugging can thus be avoided by reducing changes in the linear flow rate of fuel through the outlet orifice of the injector and thereby minimizing the reduction in pressure drop across the outlet orifice.

The “outlet orifice” as used in the preceding paragraph is to be distinguished from the inlet orifices supplying the liquid fuel to the swirl chamber. A system parameter that is variable in the practice of the present invention is the discharge coefficient C_{d}, also known as the flow coefficient, at the outlet orifice. The discharge coefficient C_{d} is defined as the product of an area ratio Cₐ and a velocity coefficient Cᵥ. The area ratio Cₐ is the portion of the outlet orifice opening are that is occupied by liquid during ejection of the liquid from the swirl chamber divided by the total area of the outlet orifice. The velocity coefficient Cᵥ reflects the angle of the ejected liquid relative to the axis of the outlet orifice. For outlet flow that is fully axial, Cᵥ=1, while for outlet flow that is fully tangential, CV is zero. Thus, in any realistic situation, the value of CV is between zero and 1. For a 45° angle, for example, Cᵥ is approximately 0.7.

Thus, when the liquid flows in only a thin layer over the rim of the outlet orifice around a core of air or gas along the orifice axis, C_{d} will be only a small fraction, and as the thickness of the flowing layer increases, C_{d} will rise toward 1, reaching a maximum when the outlet orifice is flooded. When the linear velocity of the fuel through the outlet orifice is constant, the volumetric flow rate of fuel injected into the combustion chamber through the outlet orifice is directly proportional to C_{d}. Accordingly, the thrust in a rocket engine whose fuel is supplied through the outlet orifice is likewise directly proportional to C_{d} with a constant linear velocity of fuel. A constant linear velocity can be maintained by fixing the linear velocity of fuel passing through each inlet and varying the number of inlets in simultaneous use by allowing each inlet only a fully open or a fully closed condition. This can be achieved in conventional ways, notably by continuously monitoring the pressure drop across the inlet and adjusting the flow rate accordingly, or by supplying the inlets from a pressurized source and maintaining the source at a constant pressure.

For a liquid bipropellant rocket engine, the two propellants can be injected through separate injectors, each with its own swirl chamber, although with certain types of propellants, the injector can be configured to inject both propellants simultaneously. In most cases, however, multiple injectors positioned in a distinct spatial arrangement will be used for a single combustion chamber.

These and other features of the invention, as well as various preferred embodiments, are described in greater detail below.

### BRIEF DESCRIPTION OF THE DRAWINGS

FIG. 1 is a plot, adapted from published literature, of the discharge coefficient for a swirl chamber outlet orifice vs. a correlation factor that is derived from the relative radii of the swirl chamber and its inlet(s) and outlet.

FIG. 2 is a cross section of a swirl chamber of an injector of the present invention, taken along the longitudinal axis of the swirl chamber.

FIG. 3 is a cross section of a swirl chamber of an injector of the present invention, taken in a plane transverse to the longitudinal axis of the swirl chamber.

FIG. 4 is a cross section of an inlet supply line to a swirl chamber of an injector of the present invention, taken along the longitudinal axis of the supply line.

FIG. 5 is a diagram of an injector system of the present invention.

### DETAILED DESCRIPTION OF THE INVENTION AND PREFERRED EMBODIMENTS

The swirl chamber is a flow-through receptacle, preferably a body of revolution around a longitudinal axis, that receives an incoming liquid steam and causes the liquid to circulate within the chamber in a swirling motion around the axis to form a vortex of the liquid before the liquid leaves the chamber. The outlet orifice is thus preferably circular, and preferably has a width or diameter that is smaller than other internal portions of the chamber so that diameter of the swirling path of the liquid decreases as the liquid approaches the outlet orifice. The outlet orifice can have the same diameter as the swirl chamber itself, although in preferred embodiments of the invention, the diameter ratio of the widest section of the chamber to the outlet orifice is about 2:1 or greater, or more preferably about 3:1 to about 6:1. This decrease in diameter increases the dispersion angle of the fuel ejected through the outlet orifice into the combustion chamber or engine, forming a stream in the form of a hollow cone whose angle depends on the geometry of the swirl chamber.

The inlets are configured to direct the incoming liquid along directions that do not intersect the axis of the swirl chamber and to thereby cause the liquid to encircle the axis in a circular or swirling motion. The inlet direction can be described as “tangential” although it is not strictly necessary that the angle of entry be so close to the wall of the chamber that the incoming liquid immediately contacts the wall. The outlet orifice is coaxial with the longitudinal axis of the swirl chamber so that the ejected liquid is evenly and uniformly distributed around the orifice rim. The inlets are configured such that all liquid entering the swirl chamber follows a unidirectional circular or spiral flow path, i.e., that all of the entering liquid flows in the clockwise direction or all of it flows in the counter-clockwise direction. Flow of the liquid toward the outlet orifice of the swirl chamber can be achieved by the force of the incoming liquid, or by shaping the inlet orifices to direct the flow in a plane that is at an angle. Thus, the direction of flow emerging from any single inlet can be perpendicular to, although not intersecting, the axis of the chamber, or the incoming flow can be in a plane that is at an acute angle, generally less than 30°, to the perpendicular to immediately produce a spiral flow pattern of the liquid. A spiral flow pattern can also be promoted by placing spiral grooves along the internal wall of the swirl chamber.

In preferred embodiments of the invention, a single source of fuel or propellant is used to supply each of the inlets, or when two or more propellants are fed through separate inlets, each of the inlets for the same propellant. Flow of propellant through the inlet in these embodiments is achieved by pressurization of the source. When inlets of different cross sectional areas are present, a uniform flow rate through all inlets from the same pressurized source can be achieved by engineering the inlet interiors to control the pressure drop. The high flow rates that would otherwise result from excessive pressure drops, for example, can be reduced by the inclusion of internal orifices or other types of flow restrictors. Narrow inlets with cross sections at the low end of the range may for example require such restrictors.

The number of inlets to the swirl chamber may vary widely and is not critical to the invention, provided that there be a plurality of inlets and the means to open individual inlets or groups of inlets of the plurality to flow and to select the inlets that are thus actuated. In preferred embodiments of the invention, the number of inlets is three or more, up to as many as 100 or more, with the capability of choosing between actuating only one of the inlets, two or more but less than all of the inlets, or all of the inlets, either by automation or at the direction of an operator of the injector. The position of the inlets on the inner wall of the swirl chamber is not critical. The inlets can be axially or circumferentially separated from each other, or both. Reactive forces from the jets of incoming liquids can be balanced by arranging the inlets symmetrically around the longitudinal axis of the swirl chamber for actuation in opposing pairs or groups of three or more. In certain embodiments, however, it may be beneficial to position either all inlets or groups of inlets in a common plane perpendicular to the longitudinal axis to cause all liquid flowing through the swirl chamber to follow a the same spiral path.

Variations in the volumetric flow rate can be achieved either by selectively actuating, i.e., supplying liquid fuel through, individual inlets or groups of inlets. In preferred embodiments, the range of variation can be such that the ratio of the highest cross sectional area to the lowest cross sectional area of actuated inlets is at least about 2, preferably at least about 4, and most preferably at least about 6. These different cross sectional areas can be achieved by individually actuating inlets of different cross sectional areas or by combining different numbers of inlets of the same cross sectional area, or both.

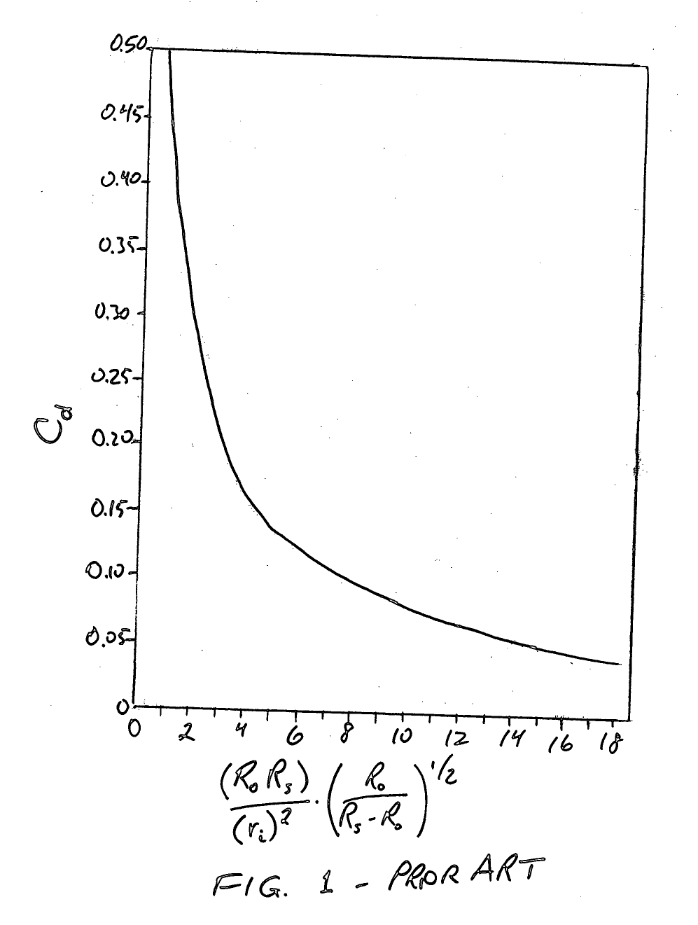

As noted above, when the linear velocity of the liquid ejected through the outlet orifice remains constant, or substantially constant, the volumetric flow rate of liquid ejected through the orifice, and hence the thrust in the engine into which the fuel is ejected, are directly proportional to the discharge coefficient C_{d}. The value of C_{d} is empirically correlated with the dimensions of the swirl chamber and the inlet and outlet orifices by the relation shown in FIG. 1, adapted from a similar plot in the Marshall paper above at page 24, FIG. 35, in which the abscissa is:

$$\frac{( {R}_{o} {R}_{s} )}{{( {r}_{i} )}^{2}} \cdot {( \frac{{R}_{o}}{{R}_{s} - {R}_{o}} )}^{1 / 2}$$

In the above formula, Rₒ is the radius of the outlet orifice; rᵢ is the collective inlet orifice radius for all actuated inlets, i.e., the square root of the ratio of the total of the cross sectional areas of all actuated inlets to π; and Rₛ is the radius of the widest portion of the swirl chamber.

The definitions above assume that the swirl chamber has a circular cross section, and that the inlet and outlet orifices are likewise circular. Throughout this specification and claims, any reference to a radius, area, or cross section of an inlet refers to the projection of the inlet onto a plane that is perpendicular to the axis of the inlet, recognizing that the actual inlet opening through which the inlet empties into the swirl chamber will in many cases be at an angle to this plane due to the curvature of the swirl chamber wall and therefore often elliptical in shape or otherwise asymmetrical about the inlet axis.

To illustrate the use of FIG. 1, an illustrative embodiment of a swirl chamber is one in which the ratio of Rₛ to Rₒ is 2.0. For a low thrust, a value of rᵢ can be selected such that the ratio of rᵢ to Rₒ is one-third, or 0.33. This results in a correlating factor (by the above formula) of 18, which, according to FIG. 1, correlates with a discharge coefficient C_{d} of 0.05. For a high thrust, an inlet or combination of inlets can be selected with a value of rᵢ such that the ratio of rᵢ to Rₒ is 3.0. The correlating factor is then 0.22, and the discharge coefficient C_{d} is well in excess of 0.50 and approaching 1.0.

The actuation of the inlets, i.e., the opening of inlets to allow passage of liquid fuel through the inlets to the swirl chamber, is done in a selective manner, which term is used herein to denote that the injector is provided with the capability of actuating less than all of the inlets or all of the inlets at the choice of an operator or of control components in the injector. Throttling is thereby achieved by decreasing C_{d} in stages by stepwise reduction of the number of actuated inlets. The means of achieving this selectivity or stepwise reduction is not critical to the invention and can vary widely. In a relatively primitive form, for example, the selectivity can be achieved by individual on-off valves, operated either manually, by pressure actuation, or by solenoid. Alternatively, selectivity can be achieved by a stepping valve or a series of stepping valves. A further alternative is the use of a movable closure such as a sleeve or piston enclosed in a flow distribution chamber that is common to all inlets or to series of inlets, the sleeve or piston selectively closing either individual inlets or groups or inlets according to the position of the sleeve or piston in the chamber, or successively closing a row of inlets, the number that are closed depending on the position of the sleeve or piston. As noted above, the liquid fuel to all inlets can be supplied from a common reservoir through individual supply lines or groups of lines. The flow distribution chamber will be positioned between the reservoir and these supply lines.

The supply lines can be molded, drilled or cast into the wall of the swirl chamber. When a large number of supply lines are desired, particularly those that are of small dimensions, the swirl chamber wall can be formed by platelet technology. Platelet technology is well known in the art, and a representative description can be found in U.S. Pat. No. 5,387,398 (Mueggenburg et al., issued Feb. 7, 1995) and U.S. Pat. No. 5,804,066 (Mueggenburg et al., issued Sep. 8, 1998), the contents of each of which are incorporated herein by reference in their entirety. As described in these patents, individual platelets (thin metallic sheets) are chemically etched through masks, then laminated by either diffusion bonding, roll bonding, or brazing. Diffusion bonding is achieved by hot-pressing the platelets together at pressures of 1000 to 3000 psi (6.9 to 20.7 MPa) and temperatures of 450° C. to 550° C. The thickness of each platelet will range from about 0.001 inch (0.00254 cm) to about 0.025 inch (0.064 cm). The total number of platelets in the laminate will be determined by the desired dimensions of the swirl chamber, the number and arrangement of the supply lines, the anticipated stress load, and other general matters of construction, as well as the ability to withstand the conditions expected to be encountered during use. In most cases, the number of platelets will range from 10 to 2,500, and preferably from 20 to 500. Copper, steel, and aluminum are suitable platelet materials, although other metals can be used as well.

As the descriptions above indicate, this invention is capable of implementation in a variety of ways. The invention and its scope can be readily understood however by a detailed examination of specific embodiments. One such embodiment is shown in the drawings and described below.

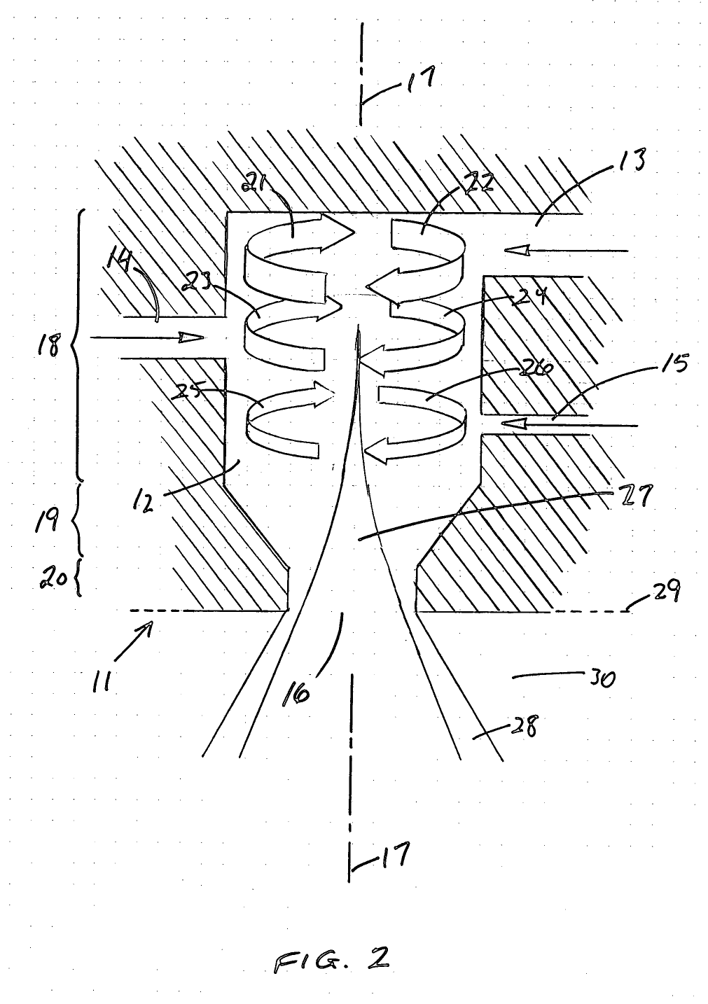

FIG. 2 depicts, in cross section, an injector 11 whose visible components are a swirl chamber 12, three inlet orifices 13, 14, 15, and an outlet orifice 16. The swirl chamber 12 is a body of revolution around a longitudinal axis 17, and contains a cylindrical section 18, a tapering section 19, and a relatively narrow throat 20 leading to the outlet orifice 16. The cylindrical section 19, throat 20, and outlet orifice 16 are coaxial, all of circular cross section centered around the longitudinal axis 17. The inlets 13, 14, 15, by contrast, are tangentially oriented, causing the liquid inside the swirl chamber to flow in a circular path or swirling motion as indicated by the arrows 21, 22, 23, 24, 25, 26, with a gap 27 in the center. The gap is occupied by gas, such as air or combustion gas from the combustion chamber downstream. As the swirling liquid proceeds toward the outlet orifice 16, the gap 17 widens due to the increasing tangential velocity of the liquid in the tapering section 19, and the liquid leaves the outlet orifice 16 as a hollow cone 28. The discharge coefficient C_{d} is the ratio of cross sectional areas at the plane 29 of the outlet orifice, specifically the cross sectional area occupied by the liquid divided by the total of the cross sectionals areas occupied by the liquid and by the gap. The combustion chamber or engine 30 is located at the outlet of the orifice 16.

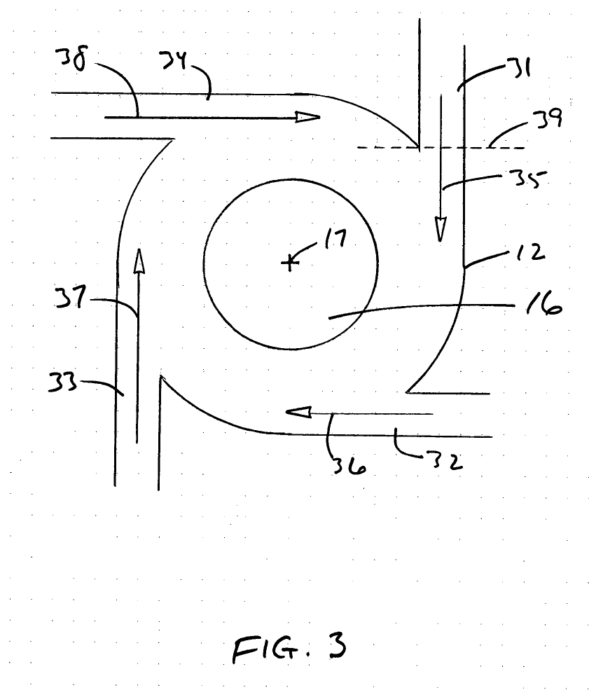

The three inlets shown in FIG. 2 are each of different sizes, and each at different distances along the longitudinal axis 17. An alternative view is shown in FIG. 3 where four inlets are shown, all of the same size and all at the same distance along the longitudinal axis. FIG. 3 is a cross section taken perpendicular to the longitudinal axis 17 of FIG. 2. The view of FIG. 3 shows four inlets 31, 32, 33, 34, arranged symmetrically around the longitudinal axis 17, each directing an incoming stream tangentially relative to the swirl cup 12 in the directions of the arrows 35, 36, 37, 38. The cross section where the radius or cross sectional area of each inlet orifice is defined is indicated by the dashed line 39 which marks the orientation of the plane at which the cross section is taken.

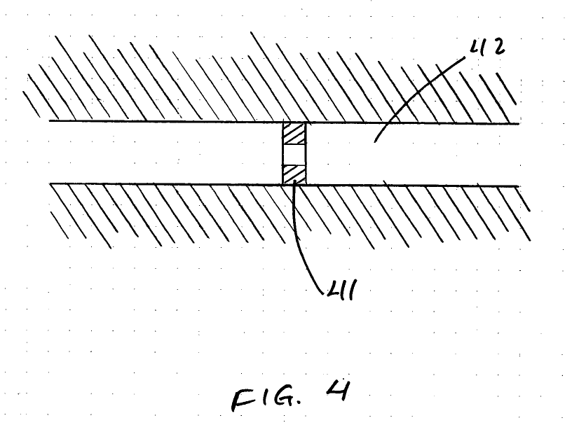

As noted above, in certain embodiments of the invention, smaller inlets may include a flow restrictor to reduce the flow that might otherwise result from an excessive pressure drop across the inlet when larger inlets are closed. FIG. 4 illustrates one such flow restrictor 41 in an inlet 42.

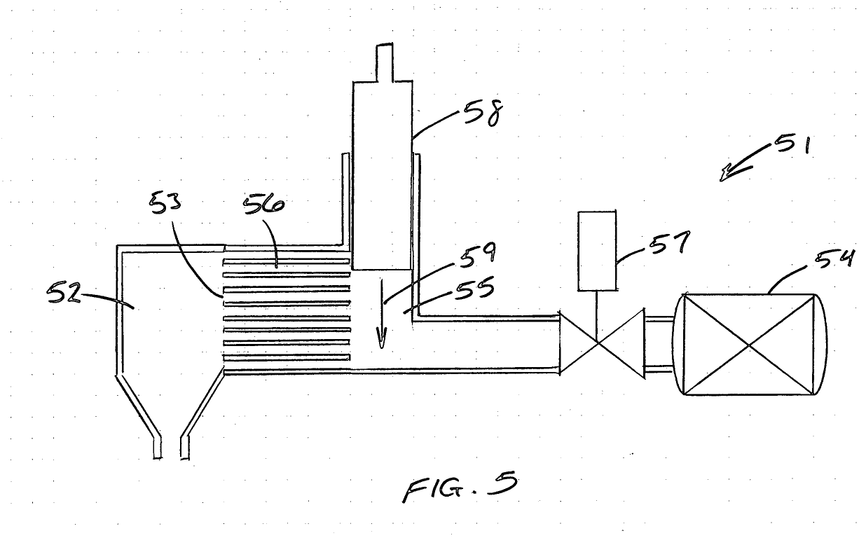

FIG. 5 is a diagram of an injector system 51 incorporating embodiments of this invention. This is a simplified representation, showing a swirl chamber 52, a series of inlets 53 all on one side for ease of depiction, a pressurized reservoir 54 for liquid fuel, a flow distribution chamber 55 between the reservoir and the inlets 53, a series of supply lines 56 between the flow distribution chamber 55 and the inlets 53, and a shutoff valve 57 between the reservoir 54 and the flow distribution chamber 55. A movable piston-like closure 58 is disposed inside the flow distribution chamber 55 for movement in the direction of the arrow 59. The closure 58 interrupts the flow into the supply lines 56, and as the closure is lowered, in the orientation shown in the Figure, the closure interrupts the flow to an increasing number of supply lines 56 and thereby throttles down the engine (not shown) by shutting off flow to an increasing number of inlets 53.

Injectors in accordance with this invention are useful for any kind of liquid fuel or propellant. For bipropellants that combust upon contact, the propellants must be kept out of contact until the reach the combustion chamber. This can be done by using separate injectors for the two propellants, or by using specially constructed injectors that contain a length of tubing extending along the axis of the swirl chamber such that one propellant can be fed through the tubing in a non-swirling configuration and the other around the tubing in a swirling configuration. When the bipropellant combination is fed through multiple injectors, however, it is preferable to use individual injectors for the two propellants, arranged in close proximity in an alternating one-dimensional or two-dimensional array.

The foregoing description focuses on particular embodiments of the invention for purposes of explanation and illustration. Further embodiments and modifications of the above will be apparent to those skilled in the art upon reviewing this description, such embodiments and modifications falling within the scope of the invention.

What is claimed is:

1. A throttling injector for injecting liquid fuel into a combustion chamber, said throttling injector comprising:
a swirl chamber having a longitudinal axis and orifices comprising (i) a plurality of inlets configured to direct liquid fuel into said swirl chamber along directions not intersecting said axis whereby said inlets create circular flow of said liquid fuel around said axis, and (ii) an outlet along said axis; and
selective liquid fuel supply means for selectively supplying liquid fuel to individual inlets or groups of inlets to vary the number of inlets simultaneously supplying liquid fuel to said swirl chamber, and for varying said number without interruption of fuel supply to said swirl chamber.

2. The throttling injector of claim 1 wherein said swirl chamber comprises a cylindrical section of circular cross section and a tapering section joining said cylindrical section to said outlet, said outlet having a cross section smaller than said cross section of said cylindrical section.

3. The throttling injector of claim 1 wherein said plurality of inlets comprises inlets of different cross sectional areas.

4. The throttling injector of claim 3 wherein said different cross sectional areas extend from a lowest cross sectional area to a highest cross sectional area, with a ratio of highest to lowest cross sectional areas of at least about 2.

5. The throttling injector of claim 4 wherein said ratio of highest to lowest cross sectional areas is at least about 4.

6. The throttling injector of claim 4 wherein said ratio of highest to lowest cross sectional areas is at least about 6.

7. The throttling injector of claim 1 wherein said plurality of inlets consists of at least three inlets, and said inlet control means consists of means for selecting between communicating said reservoir with only one of said inlets, with at least two but less than all of said inlets, and with all of said inlets.

8. The throttling injector of claim 1 wherein said selective liquid fuel supply means comprises a common reservoir, supply lines communicating said reservoir with each of said plurality of inlets, and selective closure means for selectively closing individual supply lines or groups of supply lines.

9. The throttling injector of claim 8 wherein said supply lines are fed from a common flow distribution chamber between said reservoir and said supply lines, said flow distribution chamber containing a separate opening for each supply line, and said selective closure means comprises a movable sleeve or piston inside said flow distribution chamber arranged to sequentially close said openings.

10. The throttling injector of claim 1 further comprising a flow constrictor in at least one of said inlets.
